(19) United States
(12) Patent Application Publication
(10) Pub. No.: US 2008/0283786 A1
(43) Pub. Date: Nov. 20, 2008

(54) Infrared retrofit faucet controller

(76) Inventor: David L. Snodgrass, Stuart, FL (US)

Correspondence Address: COOPER & DUNHAM, LLP, 1185 AVENUE OF THE AMERICAS, NEW YORK, NY, 10036, US

(21) Appl. No.: 11/804,675

(22) Filed: May 18, 2007

(51) Int. Cl. F16K 31/02

(52) U.S. Cl. 251/129.04

(57) ABSTRACT

A faucet control apparatus adapted for retrofitting in a faucet system having a faucet spout removable from a faucet base comprises a body having a water inlet adapted to be connected to the outlet side of a faucet base, and a water outlet adapted to accept the water inlet of a faucet spout, a sensor in the body for detecting the presence of a person's hands beneath the outlet side of the faucet spout, and a water valve in the body responsive to the sensor, which valve is in a normally closed position but which opens in response to the presence of a person's hands beneath the outlet side of the faucet spout as detected by the sensor.

### BACKGROUND OF THE INVENTION

The present invention relates to faucet controllers which turn on the water flow in response to sensing the presence of a person's hands beneath a water spigot, and more particularly to a retrofit faucet controller adapted for retrofit application to an existing faucet.

Faucet controllers have been used to turn on the water supply in response to sensing the presence of a person's hands beneath the water spigot. One example is disclosed in U.S. Pat. No. 7,104,519, entitled “Adaptor for touch-Free Operation of Gooseneck Faucet”, which is incorporated by reference herein. This patent discloses two latching solenoid valves connected below the sink deck, and an infrared (IR) sensor attached to the faucet gooseneck to detect the presence of a person's hands. Because the system has external solenoid control values, a considerable amount of labor and time is involved in installing the system in a faucet, thereby placing the system out of reach of many applications where it could desirably be used to effectively automatically control water turn-on without a user having to manually open conventional faucet valves.

Faucet controllers have been available for attachment to the outlet of a spigot, by removing the aerator and installing the controller between the spigot outlet and aerator. One such product is distributed under the name EZ Faucet of iTouchless Housewares & Products, Inc. Another is distributed under the name WaterSense of Hands Free Corporation. U.S. Pat. No. 6,420,737 is believed to describe one of these systems.

Because these systems attach to the end of a spigot, a distinct disadvantage is that has a bulky appearance, and actually takes up a considerable region of space. Another disadvantage is that such a system is typically powered by batteries which need periodic replacement. Also the only sensor is built into the unit so that the unit cannot be controlled or overridden by a controller located elsewhere.

### SUMMARY OF THE INVENTION

The present invention provides a faucet control apparatus suitable for retrofitting in a faucet system having a faucet spout or gooseneck removable from a faucet base.

The apparatus can be easily and quickly retrofitted into a faucet system without having to install faucet valves under the sink deck. The apparatus is self-contained in terms of its water connectors, valves and controller. The apparatus may include a cable for connection to hand wash controller.

The present invention provides a faucet control apparatus adapted for retrofitting in a faucet system having a faucet spout removable from a faucet base, comprising a body having a water inlet adapted to be connected to the outlet side of a faucet base, and a water outlet adapted to accept the water inlet of a faucet spout, a sensor in the body for detecting the presence of a person's hands beneath the outlet side of the faucet spout, and a water valve in the body responsive to the sensor, which valve is in a normally closed position but which opens in response to the presence of a person's hands beneath the outlet side of the faucet spout as detected by the sensor.

### BRIEF DESCRIPTION OF THE DRAWINGS

FIG. 1 is a top perspective view of one embodiment according to the invention;

FIG. 2 is a bottom perspective view of the embodiment of FIG. 1;

FIG. 3 is a cross-sectional view of the embodiment of FIG. 1; and

FIG. 4 is an exploded view of the embodiment of FIG. 1.

### DETAILED DESCRIPTION OF A PREFERRED EMBODIMENT

A preferred embodiment of the invention will be described, but the invention is not limited to this embodiment.

The present invention provides a faucet control apparatus adapted for retrofitting in a faucet system having a faucet spout removable from a faucet base, comprising a body having a water inlet adapted to be connected to the outlet side of a faucet base, and a water outlet adapted to accept the water inlet of a faucet spout, a sensor in the body for detecting the presence of a person's hands beneath the outlet side of the faucet spout, and a water valve in the body responsive to the sensor, which valve is in a normally closed position but which opens in response to the presence of a person's hands beneath the outlet side of the faucet spout as detected by the sensor.

The sensor may be an infrared sensor. The faucet control apparatus may further comprise a control circuit connected to the sensor and valve which continues to maintain the water valve open for a first predetermined time period after the sensor detects the presence of a person's hands. The faucet control apparatus may further comprise a control circuit connected to the sensor and valve which closes the valve a second predetermined time period after the sensor detects the presence of a person's hands. The sensor may have a detection sensitivity and range which may be adjusted. The faucet control apparatus may further include an integral power source. The faucet control apparatus may further include a wire connected to the sensor and valve which extends out of the body for connection to a control station. The faucet control apparatus may further include a temperature sensing device for detecting water temperature. The faucet control apparatus may further include a display on the body exterior for displaying the detected water temperature.

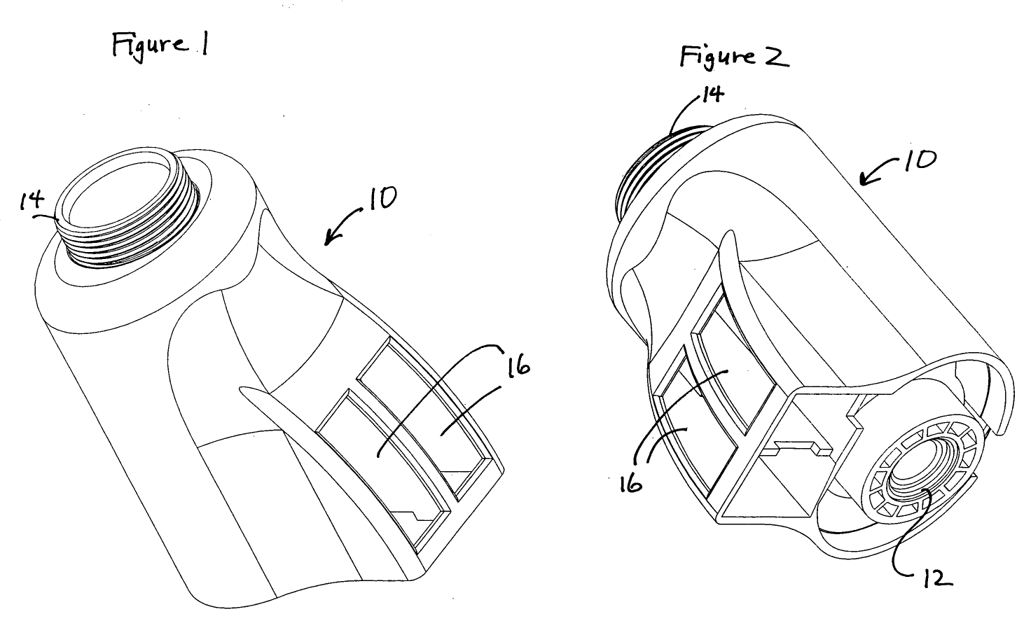

FIGS. 1 and 2 show one embodiment of a faucet controller 10 according to the invention which may be installed in a conventional gooseneck faucet. This type of gooseneck faucet has a gooseneck spout with a threaded connection at the inlet side and an aerator at the outlet side. The gooseneck threaded inlet connection is attached to the faucet controller so that the gooseneck is raised by a height equal to the height of the faucet controller. The faucet controller 10 is attached to the faucet base the same way the faucet gooseneck would be connected to the faucet base if the controller were not present. Such connection typically includes a threaded female recess 12 which can mate with a male threaded stub in the faucet base. The controller may be supplied as a commercial package with its own gooseneck spout, so that the original gooseneck spout may be discarded. The gooseneck spouts may be available in different lengths, so that after the controller is installed the gooseneck outlet can be at a desired height. The threading size and pitch of the standard gooseneck spout inlet and faucet base are typically standard sizes, to enable easy insertion of the controller between the faucet base and spout. If not standard, conversion couplings are typically available at most hardware stores, home centers and plumbing supplies to convert the thread size and pitch needed. A threaded male stub 14 on the top of the controller 10 may accept the gooseneck spout. The controller has dual infrared (IR) light emitting diodes (LEDs) behind windows 16 that are angled to optimize IR reflections over a broad range of the faucet's water column without interference from the sink. The LED angles and location may be the same as that disclosed in U.S. Pat. No. 7,104,519.

FIG. 4 shows the controller 10 in exploded view. The controller comprises a housing or body 20, a seal 22, a valve seat 24 which has the threaded outlet 14, a valve diaphragm 26, a diaphragm seat 28, a collector 30, a solenoid 32 mounted on a receiver top 34, and a receiver bottom 36, the end of which contains the threaded connection 12. The IR detectors (not shown) are connected to an electrical controller (not shown), and the solenoid 32 is also connected to the electrical controller. Wires connecting these components may exit body 20 at rear slot 20a. The electrical controller may be located outside of the body 20.

The solenoid 32 has an internal plunger (not shown) which is driven to a first open position when the solenoid is energized to actuate opening of the valve, and when not energized is biased by a spring (not shown) to a second closed position wherein the valve is closed.

Water will enter the controller through the threaded connection 12 and pass toward the right in FIG. 4 through solenoid 32 by pass-through 34a (to keep the solenoid dry) into collector 30 through part 30a. The diaphragm 26 will either let water pass to the right or not depending on whether the solenoid is energized or not. Valves of this type are well known.

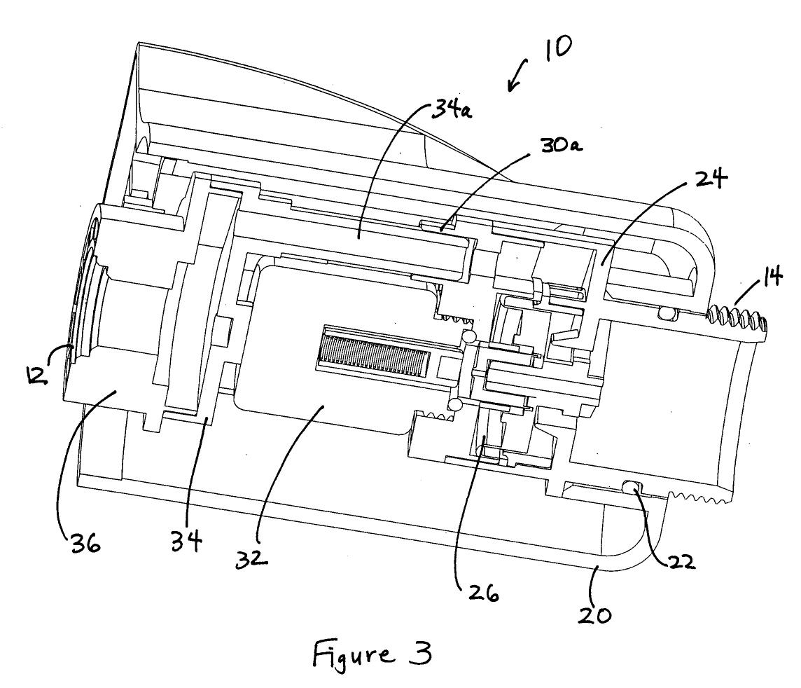

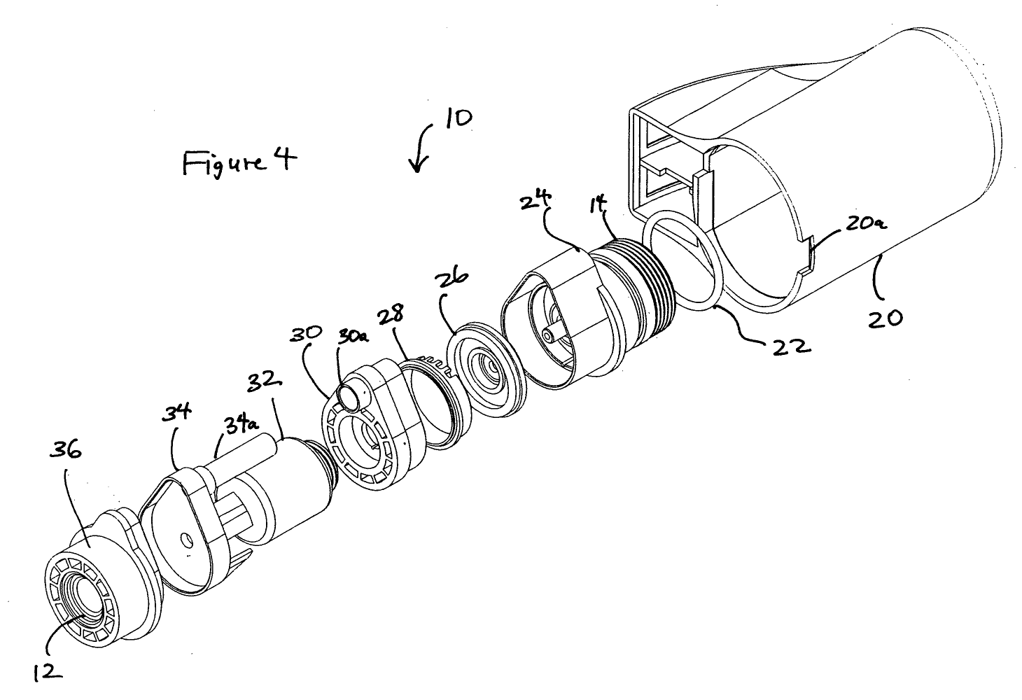

FIG. 3 shows the controller in break away or cross section. The controller defines a fluid passageway for water to flow from the left to the right, and a solenoid valve in the passageway which is normally in the closed position as biased by a spring (not shown).

When a user places a hand or object under or near the faucet spout, the IR light is reflected back to the IR LED sensor. The sensor will detect the reflection and verify that it is modulated at the correct frequency and phase. If verified, the sensor will toggle a signal back to the controller to notify that a valid reflection was detected. The IR light is modulated at about 125 kHz to reduce interference from ambient light sources.

The controller will look for ten valid reflections within a 0.5 second time period to verify that an object is near or beneath the faucet spout with the intent to activate the flow of water. When the ten reflections are detected within the 0.5 second time period, the controller will then toggle a signal to the solenoid causing the valve to open. The solenoid has a magnetic latch so only a 20 ms pulse is required to open or close the valve. The significantly reduces power consumption and allows for a battery powered option.

Once the valve is opened, the controller will continuously check the sensor. As long as a valid reflection is received, the valve will remain open. The controller features a programmable hold on time (0-10 seconds). It is typical that an object or human hand will not present a constant IR reflection to the sensor especially if it is moving. The hold on timer will keep the valve open for the programmed time in the absence of an IR reflection. If a valid reflection is detected during the hold on time, the hold on timer will be reset. This prevents sporadic interruptions of water flow while a user is using the sink.

The controller may have a programmable auto shutoff feature that will close the valve if the water has been running longer than the programmed time (5-60 seconds). This prevents the water from running continuously if an object was placed in a sink and forgotten. The controller also has a programmable auto shutoff reset time. The auto shutoff reset requires that the object be removed for a programmed time (1-10 seconds) before the valve can be opened again.

The controller also features IR range adjustability. Five range settings are independently available for both IR LEDs in the sensor/valve assembly. A range configuration can be implemented to allow the controller to work with almost any sink. The controller may have one or more of several power options, such as a stand alone device, external 12VDC power, external battery power and internal battery backup power. External 12 VDC power may provided by a standard 110VAC 60 Hz to 12VDC wall mount transformer (wall cube). The transformer may also be available for European 220VAC 50 Hz power sources. The controller may also be powered by an external battery pack. The battery pack could supply 9VDC via six c-cell batteries and power the controller and sensor/valve assembly for several months or more even with heavy use.

The controller may support an internally mounted 9V battery that can provide backup power to the controller and sensor/valve assembly if external power is lost. The backup battery could provide power for up to a week with moderate to heavy use. If the battery pack or internal backup battery voltage is low, a low battery LED indicator located in the sensor/valve assembly will blink. If external, battery or backup power to the controller is lost, the controller will automatically sense the power loss and close the valve to prevent uncontrolled water flow.

It is possible to monitor and time stamp each activation of a controller equipped faucet. The time, date and length of each activation could be stored in a nonvolatile memory for later retrieval and analysis. If the flow rate of the faucet is known and constant, actual water usage could be calculated for a given period of time.

It is possible to embed a thermocouple sensor into the sensor/valve assembly. This would allow the controller to monitor and or record the water temperature at the faucet. An additional cable may be required or a custom cable with both thermocouple wire and data wire. A display could display the water temperature to a user.

The sensor/valve assembly may be supplied with a six foot cable extending from it. This cable may be connected to the controller for a stand alone installation or directly to other control and handwash monitoring systems such as UltraClenz model G3/G4/G5 in a system installation. The cable can be routed in any number of ways. It can be routed on the outside of a wall via plastic or metal wire conduit, outside of a wall without conduit or inside of a wall and “fished” to the controller or G3/G4/G5 location.

Various details described above and other details may be found in U.S. Pat. No. 7,104,519, which is incorporated by reference herein.

Although one preferred embodiment has been described and shown in the drawings, variations will occur to those skilled in the art. The invention is not limited to the preferred embodiment and its scope is defined only by the claims.

I claim:

1. A faucet control apparatus adapted for retrofitting in a faucet system having a faucet spout removable from a faucet base, comprising:
a body having a water inlet adapted to be connected to the outlet side of a faucet base, and a water outlet adapted to accept the water inlet of a faucet spout;
a sensor in the body for detecting the presence of a person's hands beneath the outlet side of the faucet spout; and
a water valve in the body responsive to the sensor which valve is in a normally closed position but which opens in response to the presence of a person's hands beneath the outlet side of the faucet spout as detected by the sensor.

2. The faucet control apparatus of claim 1, wherein the sensor is an infrared sensor.

3. The faucet control apparatus of claim 1, further comprising a control circuit connected to the sensor and valve which continues to maintain the water valve open for a first predetermined time period after the sensor detects the presence of a person's hands.

4. The faucet control apparatus of claim 1, further comprising a control circuit connected to the sensor and valve which closes the valve a second predetermined time period after the sensor detects the presence of a person's hands.

5. The faucet control apparatus of claim 1, wherein the sensor has a detection sensitivity and range which may be adjusted.

6. The faucet control apparatus of claim 1, further including an integral power source.

7. The faucet control apparatus of claim 1, further including a wire connected to the sensor and valve which extends out of the body for connection to a control station.

8. The faucet control apparatus of claim 1, further including a temperature sensing device for detecting water temperature.

9. The faucet control apparatus of claim 8, further including a display on the body exterior for displaying the detected water temperature.
